(19) United States
(12) Patent Application Publication
(10) Pub. No.: US 2013/0300947 A1
(43) Pub. Date: Nov. 14, 2013

(54) Mini-Projector Applied for Video Output Device

(71) Applicants: Hui Hsien Wu, Hsin-Chu (TW); Wei Hong Chen, Hsin-Chu (TW); Heng Liu, Hsin-Chu (TW); Cheng Tien Chen, Hsin-Chu (TW)

(72) Inventors: Hui Hsien Wu, Hsin-Chu (TW); Wei Hong Chen, Hsin-Chu (TW); Heng Liu, Hsin-Chu (TW); Cheng Tien Chen, Hsin-Chu (TW)

(73) Assignee: Aiptek International Inc.

(21) Appl. No.: 13/467,249

(22) Filed: May 9, 2012

(51) Int. Cl. H04N 5/74; H04N 3/26; H04N 5/64

(52) U.S. Cl. 348/745; 348/744; 348/748; 348/789; 348/E05.128; 348/E05.143; 348/E03.048

(57) ABSTRACT

The present invention provides a mini-projector applied for a video output device. The video output device includes a microprocessor. A projection optical engine is coupled to the microprocessor for projecting a video data. A charging module is capable of charging to a first battery of the mini-projector and/or a second battery of the video output device. A male connector is couple to a female connector of the video output device. A switching unit is coupled to the charging module for switching the projecting function of the projection optical engine or the charging function of the second battery of the video output device.

### TECHNICAL FIELD

The present invention generally relates to a video output system, more particularly, to a mini-projector capable of directly connecting with a female connector interface of a mobile phone for projection.

### BACKGROUND

For general video devices (digital video camera or digital camera), after capturing moving or still images from outside, audio and video data will be processing and converting for digitization, and then stored in a memory built within the video devices. The operator can operate to preview dynamic or static images on screen through a display of the video devices. As the captured image data is prepared for the external projection brief, the dynamic or static images data stored in the video devices will be transmitted to a computer by a transmission line. The dynamic or static images data will be processed by the related driver and edition program of the computer for transferring the files and related processing. The computer is connected to a digital projector for playing the dynamic or static images.

Currently, as a projection brief is prepared in the public meeting, you must carry a mobile computer and a digital projector, and thereby the transferred video files of the video device rendering outside projection to show by the digital projector. To complete the projection, the video files need to be filed and stored on the computer, and a mobile computer and a digital projector are required for the digital projection. Processing procedures of conversion and transmission for the digital data are complicated. It is inconvenient for a user due to heavy and more hardware apparatus. Moreover, the conventional video projector is always combined with the computer which applications are monotonous and unchanged.

In addition, the current mobile projector can be applied to smart phones, but it needs a signal line to connect with the mini projector for signal communication, and then to project a frame on the screen. However, the mobile charging power supply device for the smart phone is free of built-in mini projector.

Therefore, based-on the shortcomings, the present invention provide a multi-functions mini-projecting applied for a mobile phone.

### SUMMARY OF THE INVENTION

An objective of the present invention is to provide users two function requirements of the projection sharing and mobile phone charging; that is to integrate and design such two functions in an identical mini-projector; and the mini-projection device can be conveniently connected to a mobile phone or a tablet PC by “Plug and play” (dongle type) without an external one transmission line, in order to achieve the two effects of image magnification projection and/or mobile power supply.

An objective of the present invention is to provide a mini-projector, wherein the mini projector can be directly connected with a female connector interface of a mobile phone for projection.

According to an aspect of the present invention, it provides a mini projector applied for a video output device, which comprises a micro-processor unit. A projection optical engine is coupled to the micro-processor unit for projecting a video data. A charging module is capable of charging to a first battery of the mini projector and/or a second battery of the video output device. A male connector is connected to a female connector of the video output device. A switching unit is coupled to the charging module for switching a projecting function of the projection optical engine or a charging function of the second battery of the video output device.

The mini projector further comprises a focusing unit coupled to the projection optical engine; an indication unit coupled to the micro-processor unit; the focusing unit coupled to a focus ring; a charging interface coupled to the charging module; the switching unit coupled to a switching key for a charging mode and a projecting function; the switching unit coupled to the micro-processor unit or the projection optical engine.

According to another aspect of the present invention, the mini projector further comprises a heat conduction medium connected or adjacent to the projection optical engine; a heat sink coupled to the heat conduction medium; wherein the heat sink is a top cover, a middle peripheral housing or a bottom cover of the mini projector.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a functional block of a mini projector and a video output device of an embodiment of the present invention;

FIG. 2 illustrates a diagram of a structure of the mini projector of an embodiment of the present invention;

FIG. 3 illustrates a diagram of a mini projector and a video output device of an embodiment of the present invention;

FIG. 4 illustrates a diagram of a structure of a mini-projector of an embodiment of the present invention;

FIG. 5 illustrates a diagram of a structure of a mini-projector of another embodiment of the present invention;

FIG. 6 illustrates a diagram of a structure of a mini-projector of yet another embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides a mini-projector, built-in male connector, which can be directly connected to a female connector of video output of the mobile phone for projection; and built-in rechargeable battery, which can charge to the battery of the mobile phone by specified switching design for software and hardware of the mini projector. The mini-projection device for the mobile phone or the tablet PC is designed by “Plug and play” (dongle type) concept without an external transmission line, and availably charging to the mobile phone or the tablet PC. Due to combo features with projection plus charging, it is greatly enhancing the portability, convenience, and multi-functional uses of the mini projector.

The present invention provides a mini-projector, with a built-in male connector electrically connected to the female connector interface of the video output device for image projection. The video output device includes a video output control unit electrically connected to the micro-processing unit of the mini-projector. In addition, the mini-projector includes a charging module or mechanism which can charge to the video output device.

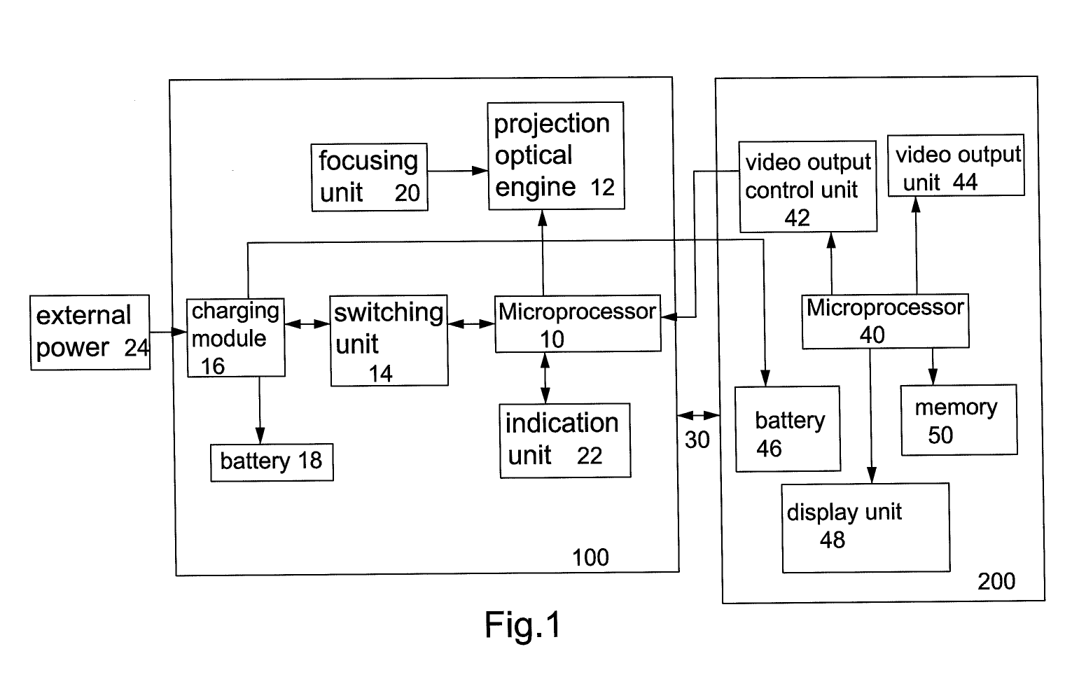

FIG. 1 shows a functional block of a mini projector and a video output device of an embodiment of the present invention. In one embodiment, the mini projector 100 may be a mobile projector, and the video output device 200 may be a portable electronic device, for example, a touch wireless video output device, a mobile phone, a smart phone (such as iPhone), a portable game console, a personal digital assistant (PDA), a notebook or a Tablet PC (such as iPad). In this embodiment, the mini projector 100 comprises a micro-processor unit 10, a projection optical engine 12, a switching unit 14, a charging module 16, a battery 18, a focusing unit 20 and an indication unit 22. The video output device 200 comprises a micro-processor unit 40, a video output control unit 42, a video output unit 44, a battery 46, a display unit 48 and a memory 50. The video output control unit 42 is coupled to the micro-processor unit 10, and the micro-processor unit 10 is coupled to the projection optical engine 12, the switching unit 14 and the indication unit 22. The focusing unit 20 is coupled to the projection optical engine 12 for facilitating adjusting the focal length of the optical lens. The indication unit 22 is coupled to the micro-processor unit 10 for indicating the battery power and/or function of switch to facilitate identifying the usage state of the device. For example, the indication unit 22 comprises a light emitting diode indicator.

For example, the video output control unit 42 is coupled to the micro-processor unit 10. The micro-processor unit 10 is a micro-processor chip. In one embodiment, a command is issued from the video output control unit 42 to the micro-processor unit 10. The video data output from the video output device 200 is processed by the micro-processor 10 and then the image projection picture is output to project by the projection optical engine 12. Magnification of the image projection picture may be adjusted which depends on the actual applications or requirements. In other words, a command issued from the video output control unit 42 may be utilized to directly or indirectly control the video picture output.

In one embodiment, the connection (or communication) mode 30 between the mini projector 100 and the video output device 200 comprises the output/input port-to-port connection, and the port (interface) of the mini projector 100 directly inserting into the port of the video output device 200.

In one embodiment, the battery 18 and the battery 46 are providing electrical power to the mini projector 100 and the video output device 200, respectively. The memory 50, the display unit 48 and the video output unit 44 are coupled to the micro-processor unit 40, respectively. The video frame may be output on the display unit 48 by its video output unit 44 of the video output device 200. The memory 50 can be for storing data, for example video data. The mini projector 100 may optionally comprises a memory for storing data.

In one embodiment, the display unit 48 comprises a LCD. Video frame, a cursor, a manipulation interface, a keyboard frame, and/or a mouse-like interface frame which may be displayed on the screen by the display unit 48.

In one embodiment, an external power source 24 is connected to the mini projector 100 for providing electrical power or charging. In this embodiment, a charging module 16 is integrated into the mini projector 100 such that the mini projector 100 becomes a mobile projector with power supply function as connected to the external power source 24. The charging module 16 is coupled to the battery 18 and the battery 46. The switching unit 14 is coupled to the micro-processor 10 for switching the charging mode of the charging module 16 to charge the battery 18 or the battery 46. In other words, as the mini projector 100 is electrically connected to the video output device 200, the battery 46 of the video output device 200 or the battery 18 of the mini projector 100 may be charged by activating the charging module 16.

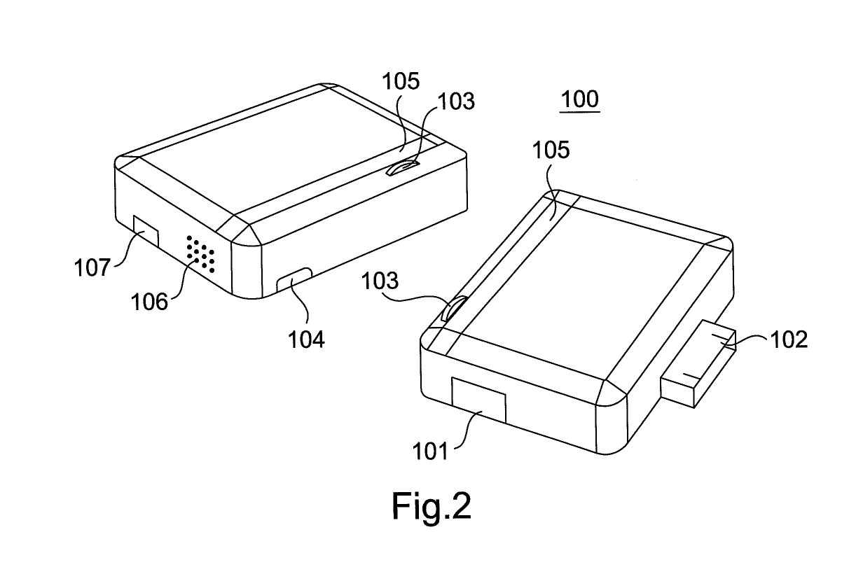

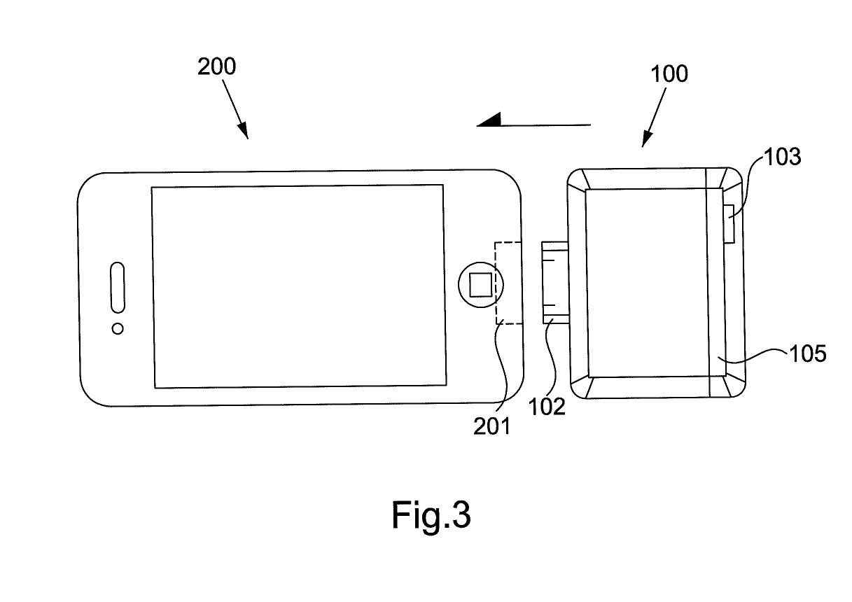

FIG. 2 shows a diagram of a structure of the mini projector of an embodiment of the present invention. In one embodiment, the structure of the mini-projector 100 comprises a projection optical engine, a printed circuit board, a battery and a male connector (for smart phone) configured inside of the structure, not shown in the figure. Moreover, the structure of the mini-projector 100 further comprises an optical lens 101, the male connector 102, a focus ring 103, a charging interface 104, an indication light 105, a speaker hole or heat dissipation hole 106 and a charging mode switching key 107 configured in the relative position of the structure of mini-projector. The optical lens 101 can be used to enlarge projected image of the mini projector 100. Light of projection may be projected to the outside via the optical lens 101. The male connector 102 of the mini projector 100 may be directly connected to a female connector 201 of the video output device 200 (such as smart phone) without additional transmission line, shown in FIG. 3. In other words, the mini projector 100 may directly connect to the smart phone by the embedded male connector. In this embodiment, the connection (or communication) mode between the mini projector 100 and the video output device 200 comprises the output/input port-to-port connection, and the port (interface) 102 of the mini projector 100 directly inserting into the port 201 of the video output device 200.

The focus ring 103 is connected to the focusing unit for adjusting the focal length of the optical lens 101. As mentioned above, a charging module is integrated into the mini projector 100 such that the mini projector 100 may be charged by the charging interface 104 connected to the external power source and the charging module. An indicator 105 is coupled to the indication unit for indicating the battery power and/or function of switch to facilitate identifying the usage state of the device. The indicator 105 is a LED indicator. The charging mode switching key 107 is connected to a switching unit for switching mode of charging. For example, by pressing charging mode switching key 107, it can switch as the video output device 200 to be charged or the mini-projector 100 to be projected. In other words, the switching key can switch between projection function of the mini projector 100 and charging function of the video output device 200. For example, the switching key is independent two buttons (keys) or a single sliding button (key).

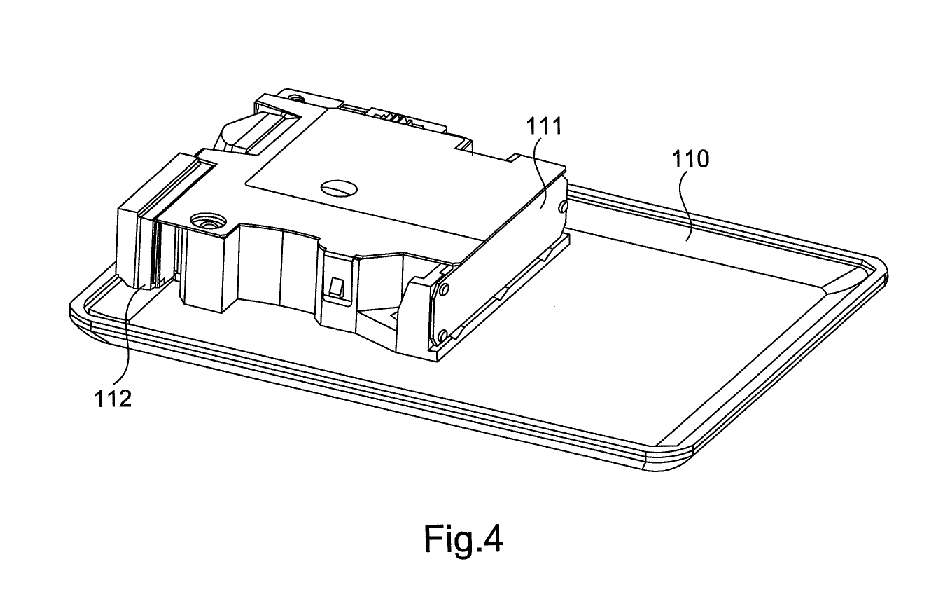

In another embodiment, the mini projector 100 further comprises a conduction medium 112 and a heat dissipation body (heat sink) 110, shown in FIG. 4. For example, the heat conduction medium 112 is connected or adjacent to the optical engine 111 and the heat sink 110, or configured near the optical engine 111, for facilitating heat generated by the optical engine 111 conducting to the heat sink 110, and followed by dissipating the heat to the outside via the heat sink 110. In a preferred embodiment, the heat conduction medium 112 is disposed near a light source of the optical engine 111, or attached to (nearly) the light source. In one embodiment, the heat sink 110 is the bottom base/cover (housing) of the mini projector 100. Material of the bottom base/cover (housing) is a heat dissipating material, and therefore the heat conduction medium 112 can conduct the heat to the bottom base. The FIG. 4 shows a mini projector with a heat sink on the bottom portion. For example, material of the heat conduction medium 112 comprises heat silicon grease, heat silicone, heat plastic, heat graphite films, heat mica, heat phase change material, metal or alloy, while materials of the heat sink 110 comprise ceramic, metal or alloy.

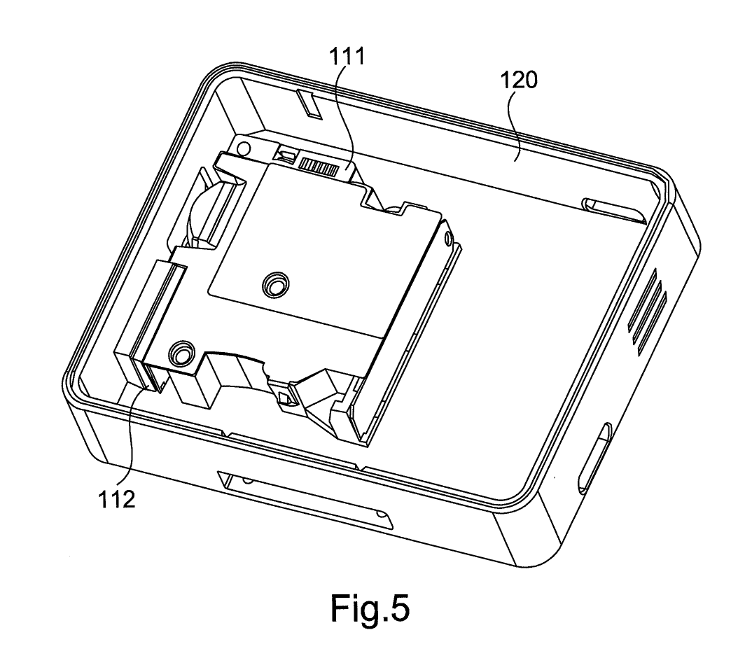

In another embodiment, the mini projector 100 further comprises a conduction medium 112 and a heat dissipation body (heat sink) 110, shown in FIG. 5. In this embodiment, the heat sink 120 is the middle portion (peripheral housing) of the mini projector 100. Material of the middle portion (peripheral housing) is a heat dissipating material, and therefore the heat conduction medium 112 can conduct the heat to the middle portion (peripheral housing). The FIG. 5 shows a mini projector with a heat sink on the middle portion (peripheral housing).

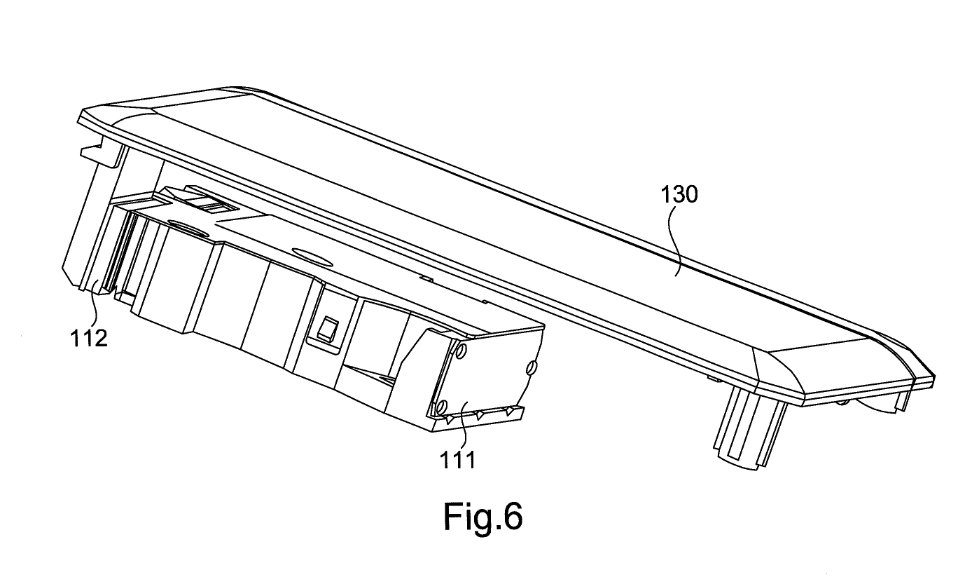

In yet another embodiment, the mini projector 100 further comprises a conduction medium 112 and a heat dissipation/conduction body (heat sink) 130, shown in FIG. 6. In this embodiment, the heat sink 130 is the top portion/cover (housing) of the mini projector 100. Material of the top portion/cover (housing) is a heat conduction material, and therefore the heat conduction medium 112 can conduct the heat to the top portion/cover (housing). The FIG. 6 shows a mini projector with a heat sink on the top portion (housing).

Moreover, the whole structure (housing) of the mini projector may be also a heat conduction material.

As above-mentioned, the mini-projector of the present invention has at least the following effects:

1. Once the micro-projector connects to a mobile phone or a tablet PC, as turning on the projecting button (key), an audio and video content of the mobile phone or the tablet PC may be projected to share with others via the mini projector.

2. Once the micro-projector connects to a mobile phone, the charging mode key may be activated to charged to the mobile phone; especially, when the battery of the mobile phone is exhausted, the mini-projector may charge to the mobile phone in case for urgent need.

3. The mini projector has an indicator for indicating the battery power and/or function of switch to facilitate identifying the usage state of the device.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. A mini projector applied for a video output device, comprising:
a micro-processor unit;
a projection optical engine, coupled to said micro-processor unit for projecting a video data;
a charging module, capable of charging to a first battery of said mini projector and/or a second battery of said video output device;
a male connector, connected to a female connector of said video output device by a port-to-port; and
a switching unit, coupled to said charging module for switching a projecting function of said projection optical engine or a charging function of said second battery of said video output device.

2. The mini projector of claim 1, further comprising a focusing unit coupled to said projection optical engine.

3. The mini projector of claim 2, further comprising an indication unit coupled to said micro-processor unit.

4. The mini projector of claim 2, wherein said focusing unit is coupled to a focus ring.

5. The mini projector of claim 1, further comprising a charging interface coupled to said charging module.

6. The mini projector of claim 1, wherein said switching unit is coupled to a switching key for a charging mode and a projecting function.

7. The mini projector of claim 6, wherein said switching key is independent two keys or a single sliding key.

8. The mini projector of claim 1, wherein said video output device comprises a touch wireless video output device, a mobile phone, a smart phone, a portable game console, a personal digital assistant (PDA), a notebook or a Tablet PC.

9. The mini projector of claim 1, further comprising a heat conduction medium connected or adjacent to said projection optical engine.

10. The mini projector of claim 9, further comprising a heat sink coupled to said heat conduction medium.

11. The mini projector of claim 9, wherein said heat sink is a top cover, a middle peripheral housing or a bottom cover of said mini projector.

12. The mini projector of claim 1, wherein said switching unit is coupled to said micro-processor unit.

13. The mini projector of claim 1, wherein said switching unit is coupled to said projection optical engine.
